(19) United States
(12) Patent Application Publication
(10) Pub. No.: US 2026/0066402 A1
(43) Pub. Date: Mar. 5, 2026

(54) SECONDARY BATTERY AND METHOD FOR MANUFACTURING THE SAME

(71) Applicant: SAMSUNG SDI CO., LTD., Yongin-si (KR)

(72) Inventor: Donghyuk KO, Yongin-si (KR)

(21) Appl. No.: 19/024,425

(22) Filed: Jan. 16, 2025

(30) Foreign Application Priority Data
Aug. 27, 2024 (KR) 10-2024-0115425

(51) Int. Cl. H01M 50/109; H01M 10/0525; H01M 10/0587; H01M 50/121; H01M 50/202; H01M 50/227; H01M 50/296; H01M 50/548; H01M 50/559; H01M 50/566

(52) U.S. Cl. CPC H01M 50/109; H01M 10/0525; H01M 10/0587; H01M 50/121; H01M 50/202; H01M 50/227; H01M 50/296; H01M 50/548; H01M 50/559; H01M 50/566

(57) ABSTRACT

A secondary battery includes an electrode assembly including a first electrode, a second electrode, and a separator, an inner case including an upper opening of which a first surface is open, a lower opening of which a second surface facing the first surface is open, and a tubular inner sidewall surrounding the electrode assembly, an upper terminal plate joined to the upper opening and electrically coupled to the first electrode, a lower terminal plate joined to the lower opening and electrically coupled to the second electrode, and an outer case including a tubular outer sidewall surrounding the inner case, an upper part extending inwardly from the outer sidewall and joined to the upper terminal plate, and a lower part extending inwardly from the outer sidewall and joined to the lower terminal plate, wherein the inner case and the outer case include an insulating material.

### CROSS-REFERENCE TO RELATED APPLICATION

This application claims priority under 35 U.S.C § 119 to Korean Patent Application No. 10-2024-0115425, filed in the Korean Intellectual Property Office on Aug. 27, 2024, the entire contents of which are hereby incorporated by reference.

### BACKGROUND

### 1. Field

Aspects of embodiments of the present disclosure relate to a secondary battery and a method for manufacturing the same.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

A secondary battery in accordance with some embodiments of the present disclosure includes an electrode assembly including a first electrode, a second electrode, and a separator, an inner case including an upper opening of which one surface is opened, a lower opening of which a surface facing the one surface is opened, and a tubular inner sidewall part configured to surround the electrode assembly, an upper terminal plate joined to the upper opening and electrically coupled to the first electrode, a lower terminal plate joined to the lower opening and electrically coupled to the second electrode, and an outer case including a tubular outer sidewall part configured to surround the inner case, an upper part extending inwardly from the outer sidewall part and joined to the upper terminal plate, and a lower part extending inwardly from the outer sidewall part and joined to the lower terminal plate, wherein the inner case and the outer case are configured of an insulating material.

According to some embodiments, the upper terminal plate may be configured to seal an upper through hole formed in a central portion of the upper part, and the lower terminal plate may be configured to seal a lower through hole formed in a central portion of the lower part.

According to some embodiments, at least a portion of the upper terminal plate may pass through an upper through hole formed in a central portion of the upper part, and at least a portion of the lower terminal plate may pass through a lower through hole formed in a central portion of the lower part.

According to some embodiments, the upper terminal plate may include an upper insertion part which may pass through an upper through hole formed in a central portion of the upper part and an upper flange part which may extend outwardly from the upper insertion part and may be joined to a bottom surface of the upper part, and the lower terminal plate may include a lower insertion part which may pass through a lower through hole formed in a central portion of the lower part and a lower flange part which may extend outwardly from the lower insertion part and may be joined to a top surface of the lower part.

According to some embodiments, the upper terminal plate may further include an upper rivet terminal disposed over the upper insertion part and joined to a top surface of the upper part, and the lower terminal plate may further include a lower rivet terminal disposed below the lower insertion part and joined to a bottom surface of the lower part.

According to some embodiments, the upper terminal plate and the lower terminal plate may be configured of a conductive material, and wherein the electrode assembly may include: a first electrode and a first electrode tab electrically coupled to the upper terminal plate, and a second electrode and a second electrode tab electrically coupled to the lower terminal plate.

According to some embodiments, the first electrode may be welded to the upper terminal plate to be coupled to the upper terminal plate, and the second electrode may be welded to the lower terminal plate to be coupled to the lower terminal plate.

According to some embodiments, the inner case and the outer case may be configured of a chemical resistance and thermoplastic material.

According to some embodiments, the material may include at least one of fluoroelastomer (FKM), polybutylene terephthalate (PBT), ethylene propylene diene monomer (EPDM), polyvinylidene fluoride (PVDF), polytetrafluoroethylene (PTFE), and silicon rubber.

According to some embodiments, a thickness of the outer case may be equal to or smaller than that of the inner case.

According to some embodiments, the upper part may be formed to have a height reduced inwardly, and the upper terminal plate may include a crimping fixing part in a surface which is in contact with the outer case.

According to some embodiments, the secondary battery may include a coin cell or a button cell.

According to some embodiments, a height of the inner case may be equal to or smaller than that of the electrode assembly.

According to some embodiments, the electrode assembly may be configured that the first electrode, the second electrode, and a separator interposed between the first electrode and the second electrode may be wound, the upper terminal plate may have a circular plate shape, and a diameter of the upper terminal plate may be larger than an inner diameter of the inner case and equal to or smaller than an outer diameter of the inner case.

A method of manufacturing a secondary battery, in accordance with some embodiments of the present disclosure, includes preparing an electrode assembly including a first electrode, a second electrode, and a separator, preparing an inner case configured of an insulating material, and including an upper opening of which one surface is opened, a lower opening of which a surface facing the one surface is opened, and a tubular inner sidewall part, preparing an outer case having a cylindrical shape, configured of an insulating material, and including a lower part having a lower through hole, an outer sidewall part coupled to the lower part, and an opening facing the lower part, inserting the electrode assembly into the inner case through the upper opening or the lower opening, electrically coupling the first electrode and the second electrode to the upper terminal plate and the lower terminal plate, respectively, inserting the electrode assembly, the inner case, the upper terminal plate, and the lower terminal plate into the outer case through the opening of the outer case, and joining the upper terminal plate, the lower terminal plate, and the outer case to each other to seal the outer case.

According to some embodiments, preparing the electrode assembly may include electrically coupling a first electrode tab to the first electrode, and electrically coupling a second electrode tab to the second electrode, and wherein the electrically coupling of the first electrode and the second electrode to the upper terminal plate and the lower terminal plate may include: welding at least a portion of the second electrode tab and at least a portion of the lower terminal plate, and bending the second electrode tab so that the lower terminal plate covers the lower opening.

According to some embodiments, electrically coupling of the first electrode and the second electrode to the upper terminal plate and the lower terminal plate may further include welding at least a portion of the first electrode tab and at least a portion of the upper terminal plate to electrically couple the first electrode and the upper terminal plate, and bending the first electrode tab so that the upper terminal plate covers the upper opening.

According to some embodiments, inserting the outer case may include passing at least a portion of the lower terminal plate through the lower through holes, and injecting an electrolyte solution into an inside of the outer case.

According to some embodiments, the method may further include aligning the upper terminal plate, the lower terminal plate, the inner case, and the outer case.

According to some embodiments, sealing the outer case may include pressurizing the outer case through a pressure jig.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a longitudinal cross-sectional view illustrating a secondary battery according to some embodiments of the present disclosure.

FIG. 2 is a perspective view illustrating a secondary battery according to some embodiments of the present disclosure.

FIG. 3 is a cross-sectional view illustrating a secondary battery according to some embodiments of the present disclosure.

FIG. 4 is a cross-sectional view illustrating a secondary battery according to some embodiments of the present disclosure.

FIG. 5 is a cross-sectional view illustrating a secondary battery according to some embodiments of the present disclosure.

FIG. 6 is a cross-sectional view illustrating a secondary battery according to some embodiments of the present disclosure.

FIG. 7 is a flowchart explaining a method for manufacturing a secondary battery according to some embodiments of the present disclosure.

FIGS. 8 to 14 are process diagrams of stages in a method for manufacturing a secondary battery according to some embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

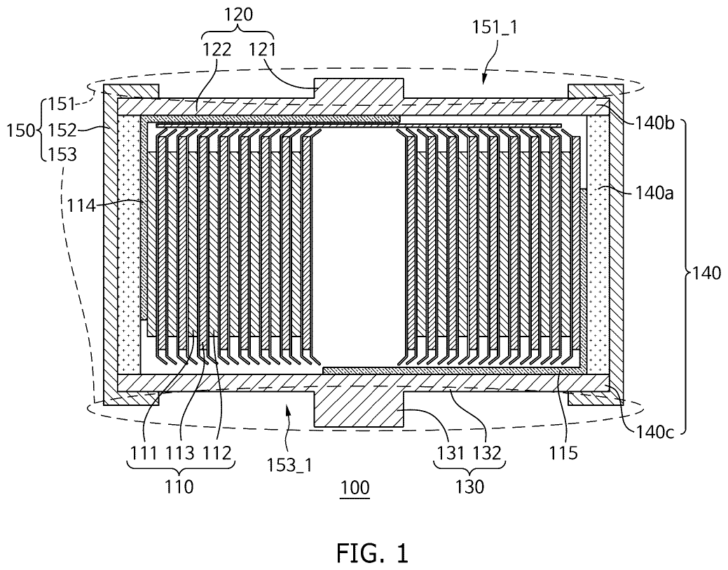

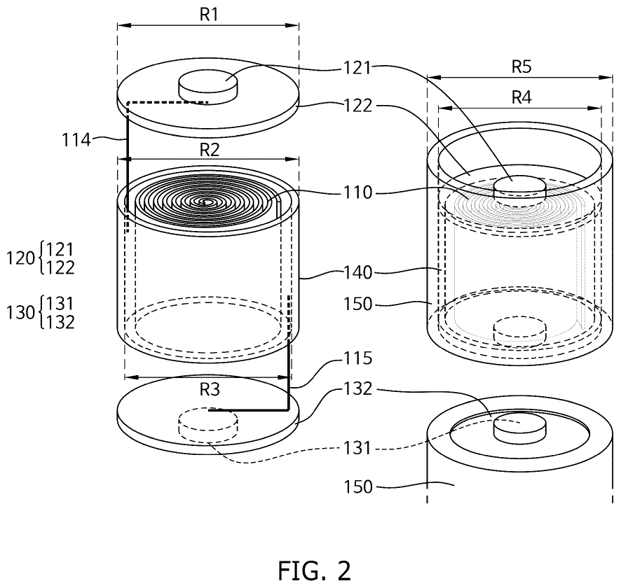

FIG. 1 is a longitudinal cross-sectional view illustrating a secondary battery 100 according to some embodiments of the present disclosure. FIG. 2 is a perspective view illustrating the secondary battery 100 according to some embodiments of the present disclosure.

Referring to FIGS. 1 and 2, the secondary battery 100 may include an electrode assembly 110, an upper terminal plate 120, a lower terminal plate 130, an inner case 140, and an outer case 150.

The secondary battery 100 may be a coin cell or a button cell. For example, the secondary battery 100 may have a cylindrical shape. In another example, the secondary battery 100 may be a prismatic-shaped battery, a pouch-shaped battery, a cylindrical-shaped battery, or the like. In some embodiments, the secondary battery 100 may be a chargeable and dischargeable secondary battery.

The electrode assembly 110 may include a first electrode 111, a second electrode 112, and a separator 113. For example, the electrode assembly 110 may be formed in such a manner that the first electrode 111, the second electrode 112, and the separator 113 disposed to be interposed between the first and second electrodes are sequentially stacked and/or wound. In another example, the electrode assembly 110 may be formed in such a manner that the first electrode, the separator, and the second electrode are sequentially stacked in a Z-stack form.

The electrode assembly 110 may include a first electrode tab 114 configured to electrically couple the first electrode and the upper terminal plate 120 and a second electrode tab 115 configured to electrically couple the second electrode and the lower terminal plate 130.

The first electrode may include a first base material and a first active material layer positioned on the first base material. The first electrode tab 114 may extend outwardly from a first uncoated portion of the first base material on which the first active material layer is not positioned. The first electrode tab 114 may be electrically coupled to the upper terminal plate 120. For example, the first electrode tab 114 may extend along a side surface of the electrode assembly 110 and may be bent in an upper edge of the electrode assembly 110 to be electrically coupled to the upper terminal plate 120.

The second electrode may include a second base material and a second active material layer positioned on the second base material. The second electrode tab 115 may extend outwardly from a second uncoated portion of the second base material on which the second active material layer is not positioned. The second electrode tab 115 may be electrically coupled to the lower terminal plate 130. For example, the second electrode tab 115 may extend along a side surface of the electrode assembly 110 and may be bent in a lower edge of the electrode assembly 110 to be electrically coupled to the lower terminal plate 130.

The first electrode may function as a positive electrode. For example, the first base material may be configured of an aluminum foil, and the first active material layer may include a transition metal oxide. The second electrode may function as a negative electrode. For example, the second base material may be configured of a copper foil or a nickel foil, and the second active material layer may include graphite.

The separator may serve to prevent the first electrode and the second electrode from being short-circuited and to allow ions to move therebetween. For example, the separator may physically separate the first electrode and the second electrode and simultaneously allow lithium (Li) ions to move through the electrolyte solution, thereby preventing short circuit and promoting the movement of the Li ions.

The separator may have a porous structure so as to facilitate the movement of the Li ions and prevent electrical short circuit between the first electrode and the second electrode. For example, the separator may be configured of a polyethylene film, a polypropylene film, a multilayer film of polyethylene and polypropylene, and the like. In another example, the separator may include a film in which a ceramic material is coated on a polymer substrate and a film manufactured of nanofiber through an electrical spin method.

In some embodiments, an outer circumference of the electrode assembly 110 may be finished with a specific material. For example, the specific material may be disposed to wrap the outer circumference of the electrode assembly 110. In this example, the specific material may be a negative electrode material or a positive electrode material.

In some embodiments, the electrode assembly 110 may include a finishing tape which wraps at least a portion of an outermost circumference of the electrode assembly 110. The finishing tape may fix the wound electrode assembly 110. For example, the winding of the first electrode, the second electrode, and the separator of the electrode assembly 110 may not be loose and may be maintained by the finishing tape. For example, the finishing tape may have adhesion to be bonded to at least a portion of the outermost circumference of the electrode assembly 110.

In some embodiments, the first electrode tab 114 may protrude from one side of the electrode assembly 110. The first electrode tab 114 may be folded below the upper terminal plate 120 in the inner case 140 which the electrode assembly 110 is accommodated therein and the upper terminal plate 120 is joined thereto. According to some embodiments, the secondary battery 100 may not include a configuration such as an insulating washer for insulating the first electrode tab 114. According to other embodiments, the secondary battery 100 may include the insulating washer, and the short circuit between the folded first electrode tab 114 and the electrode assembly 110 may be prevented by the insulating washer. The insulating washer may be disposed between the electrode assembly 110 and the first electrode tab 114. For example, the insulating washer may be disposed between the first electrode tab 114 positioned below the upper terminal plate 120 and the electrode assembly 110. The insulating washer may include an insulating material. The insulating washer may separate the first electrode tab 114 and the electrode assembly 110 to be spaced apart from each other. The insulating washer may electrically insulate the first electrode tab 114 and the electrode assembly 110.

In some embodiments, the second electrode tab 115 may protrude from the other side of the electrode assembly 110 opposite to the direction that the first electrode tab 114 protrudes from the electrode assembly 110. The second electrode tab 115 may be folded over the lower terminal plate 130 joined to a lower opening 140c of the inner case 140. According to some embodiments, the secondary battery 100 may not include a configuration such as an insulating washer for insulating the second electrode tab 115. According to other embodiments, the secondary battery 100 may include the insulating washer, and the short circuit between the folded second electrode tab 115 and the electrode assembly 110 may be prevented by the insulating washer. The insulating washer may be disposed between the electrode assembly 110 and the second electrode tab 115. For example, the insulating washer may be disposed between the second electrode tab positioned over the lower terminal plate 130 and the electrode assembly 110. The insulating washer may include an insulating material. The insulating washer may separate the second electrode tab 115 and the electrode assembly 110 to be spaced apart from each other. The insulating washer may electrically insulate the second electrode tab 115 and the electrode assembly 110.

For example, referring to FIG. 1, the first electrode tab 114 extending from the first electrode may be coupled to the upper terminal plate 120 and the second electrode tab 115 extending from the second electrode may be coupled to the lower terminal plate 130. In another example, the first electrode tab 114 may be coupled to the lower terminal plate 130, and the second electrode tab 115 may be coupled to the upper terminal plate 120. In this example, the lower terminal plate 130 coupled to the first electrode tab 114 may function as a positive electrode terminal, and the upper terminal plate 120 coupled to the second electrode tab 115 may function as a negative electrode terminal.

The inner case 140 may have a tubular shape or a cylindrical shape of which a top surface and a bottom surface are opened, and the electrode assembly 110 may be built in the inside of the inner case 140. For example, the inner case 140 may include an upper opening 140b of which a first surface is open, a lower opening 140c of which a second surface facing the first surface, in which the upper opening 140b is positioned, is open, and a tubular inner sidewall part 140a which surrounds the electrode assembly 110. It can be understood in the present disclosure that the inner case 140 refers to the inner sidewall part 140a. The electrode assembly 110 may pass through at least one of the upper opening 140b and the lower opening 140c of the inner case 140 to be inserted into the inside of the inner case 140, and may be disposed to be surrounded by the inner sidewall part 140a of the inner case 140. For example, the inner sidewall part 140a may be in direct contact with the outer circumference of the electrode assembly 110 to wrap the electrode assembly 110 or the inner sidewall part may be spaced apart from the electrode assembly 110 to surround the electrode assembly 110.

The inner case 140 may have a tubular shape, e.g., a tubular structure having a circular cross section. The inner case 140 may have a tubular shape, e.g., a prismatic or pouch-shaped structure having a rectangular cross section. The inner case 140 may have a shape corresponding to the electrode assembly 110. For example, when the electrode assembly 110 is z-stacked, the inner case 140 may be configured as a tubular shape having a rectangular cross section, such as a pouch-shaped battery case or a prismatic-shaped battery case.

The inner case 140 may be configured of a chemically resistant, thermoplastic, and insulating material. For example, the inner case 140 may include at least one of polypropylene (PP), polyethylene (PE), fluoroelastomer (FKM), polybutylene terephthalate (PBT), ethylene propylene diene monomer (EPDM), polyvinylidene fluoride (PVDF), polytetrafluoroethylene (PTFE), and silicon rubber.

The inner case 140 may accommodate the electrode assembly 110 and the electrolyte solution in the inside thereof. For example, the electrode assembly 110 may be inserted into the inner case 140 through the upper opening 140b or the lower opening 140c formed in one side of the inner case 140. The inner sidewall part 140a of the tubular inner case 140 may surround the electrode assembly 110 (e.g., completely surround a perimeter of the electrode assembly 110). Then, the upper and lower openings 140b and 140c of the inner case 140 may be sealed with the terminal plates 120 and 130, respectively.

The upper opening and the lower opening of the inner case 140 may be joined to the upper terminal plate 120 and the lower terminal plate 130, respectively. For example, the upper opening of the inner case 140 may be covered and sealed with the upper terminal plate 120. The lower opening of the inner case 140 may be covered and sealed with the lower terminal plate 130.

For example, a height of the inner case 140 may correspond to (e.g., equal) a height of the electrode assembly 110. The height of the inner case 140 may refer to a length between the one surface of the inner case 140 in which the upper opening is positioned and the surface of the inner case 140 which faces the one surface and the lower opening is positioned therein. For example, the electrode assembly 110 may be disposed in the inside of the tubular inner case 140 to be surrounded with the inner sidewall part, and the openings of the inner case 140 may be joined to the terminal plates to be sealed. In this example, the height of the inner case 140 may be substantially the same as that of the electrode assembly 110 accommodated in the inside of the inner case 140. In another example, the height of the inner case 140 may be larger or smaller than that of the electrode assembly 110.

In some embodiments, the height of the electrode assembly 110 before being inserted into the inner case 140 may be smaller than that of the inner case 140. However, the electrode assembly 110 may expand by a predetermined size through an electrolyte solution impregnating process, so that the height of the electrode assembly 110 accommodated in the inner case 140 may be substantially the same as that of the inner case 140.

In some embodiments, the height of the electrode assembly 110 before being inserted into the inner case 140 may be larger than that of the inner case 140. However, in a process of joining the upper opening and the lower opening of the inner case 140 to the upper terminal plate 120 and the lower terminal plate 130, respectively, the electrode assembly 110 may be compressed within a range which does not affect a function of the electrode assembly 110. In other embodiments, the electrode assembly 110 may be compressed within a range which does not affect a function of the electrode assembly 110 through a process of crimpling and pressurizing the outer case 150. Accordingly, the height of the electrode assembly 110 accommodated in the inner case 140 may be substantially the same as that of the inner case 140.

The upper terminal plate 120 may be configured of a conductive material. The upper terminal plate 120 may be electrically coupled to the first electrode of the electrode assembly 110. For example, at least a portion of one surface of the upper terminal plate 120 may be welded to the first electrode tab extending from the first electrode of the electrode assembly 110 so that the upper terminal plate 120 may be electrically coupled to the first electrode of the first electrode assembly 110. In another example, the first electrode tab may be clamped to the upper terminal plate 120 or the first electrode tab may be mechanically fixed to the upper terminal plate 120 by a rivet. In yet another example, the first electrode tab may be adhered to the upper terminal plate 120 using a conductive adhesive.

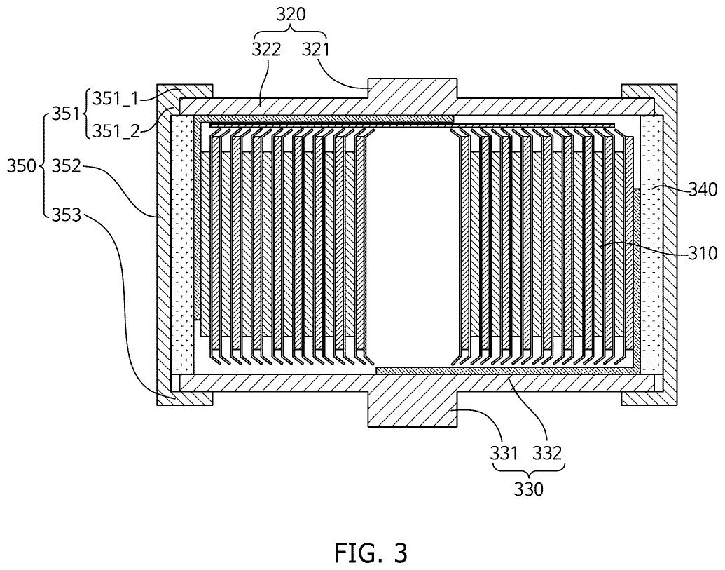

The upper terminal plate 120 may be joined to the upper opening of the inner case 140. For example, the upper terminal plate 120 electrically coupled to the first electrode of the electrode assembly 110 may cover the upper opening. In this example, the upper terminal plate 120 and the inner case 140 may be configured of a conductive material and an insulating material, respectively, and thus a short circuit between the inner case 140 and the upper terminal plate 120 may not occur. Various embodiments for a coupling relationship between the upper terminal plate 120 and the inner case 140 will be described later with reference to the following drawings starting with FIG. 3.

The lower terminal plate 130 may be configured of a conductive material. The lower terminal plate 130 may be electrically coupled to the second electrode of the electrode assembly 110. For example, at least a portion of one surface of the lower terminal plate 130 may be welded to the second electrode tab extending from the second electrode of the electrode assembly 110 so that the lower terminal plate 130 may be electrically coupled to the second electrode of the electrode assembly 110. In another example, the second electrode tab may be clamped to the lower terminal plate 130 or the second electrode tab may be mechanically fixed to a top surface of the lower terminal plate 130 by a rivet. In yet another example, the second electrode tab may be adhered to the lower terminal plate 130 using conductive adhesive.

The configuration or method in which the upper terminal plate 120 and the first electrode are electrically coupled may be independent of the configuration or method in which the lower terminal plate 130 and the second electrode are electrically coupled. For example, the upper terminal plate 120 and the first electrode may be welded to be electrically coupled to each other, but the lower terminal plate 130 and the second electrode may be adhered by conductive adhesive to be electrically coupled to each other.

The lower terminal plate 130 may be joined to the lower opening of the inner case 140. For example, the lower terminal plate 130 electrically coupled to the second electrode of the electrode assembly 110 may cover the lower opening. In this example, the lower terminal plate 130 and the inner case 140 may be configured of a conductive material and an insulating material, respectively, and thus a short circuit between the inner case 140 and the lower terminal plate 130 may not occur.

Referring to FIG. 2, the first electrode, the separator, and the second electrode of the electrode assembly 110 may be sequentially stacked and wound. In some embodiments, the tubular inner case 140 may have a tube shape with a ring-shaped cross section or a circular-shaped cross section. The upper terminal plate 120 covering the upper opening of the inner case 140 may have a circular plate shape in a cross-section. For example, as illustrated in FIG. 2, a diameter R1 of one surface of the upper terminal plate 120 covering the upper opening of the inner case 140 may be equal to an outer diameter R2 of the inner case 140. In another example, the diameter R1 of the one surface of the upper terminal plate 120 may be equal to or smaller than the outer diameter R2 of the inner case 140 and larger than an inner diameter R3 of the inner case 140. Various embodiments thereof will be described later with reference to the following drawings starting with FIG. 3.

Referring to FIG. 1, the outer case 150 may include an upper part 151, an outer sidewall part 152, and a lower part 153. The outer case 150 may accommodate the upper terminal plate 120, the lower terminal plate 130, and the inner case 140 in the inside (e.g., interior) thereof.

In some embodiments, the tubular outer sidewall part 152 may surround the inner case 140 (e.g., may completely surround a perimeter of the inner case 140). The upper part 151 may extend inwardly from the outer sidewall part 152 and may be joined to the upper terminal plate 120, e.g., the upper part 151 may extend radially and perpendicularly from the tubular outer sidewall part 152 toward the interior of the outer case 150 along an entire circumference of the outer case 150. The lower part 153 may extend inwardly from the outer sidewall part 152 and may be joined to the lower terminal plate 130, e.g., the lower part 153 may extend radially and perpendicularly from the tubular outer sidewall part 152 toward the interior of the outer case 150 along the entire circumference of the outer case 150. For example, referring to FIG. 1, the upper and lower parts 151 and 153 may extend from opposite ends of the outer sidewall part 152.

In some embodiments, an upper through hole 151_1 may be formed in a central portion of the upper part 151 of the outer case 150. The upper terminal plate 120 may seal the upper through hole 151_1 formed in the central portion of the upper part 151. For example, at least a portion of the upper terminal plate 120 may pass through the upper through hole 151_1 formed in the central portion of the upper part 151.

In some embodiments, the upper terminal plate 120 may include an upper insertion part 121 and an upper flange part 122. For example, in relation to the outer case 150, the upper insertion part 121 may pass through the upper through hole 151_1 formed in the central portion of the upper part 151 of the outer case 150. The upper flange part 122 may extend outwardly from the upper insertion part 121 and, in relation to the outer case 150, the upper flange part 122 may be joined to a bottom surface of the upper part 151 of the outer case 150. In relation to the inner case 140, the upper flange part 122 may cover the upper opening of the inner case 140, and the upper flange part 122 may be electrically coupled to the first electrode of the electrode assembly 110. For example, referring to FIG. 1, a peripheral region of the upper terminal plate 120 (e.g. an edge of the upper flange part 122) may be inserted between and held between a topmost surface of the inner case 140 (e.g., a surface of the inner sidewall part 140a facing the upper part 151) and the bottom surface of the upper part 151 (e.g., a surface of the upper part 151 facing the inner case 140) along an entire circumference of the inner case 140.

For example, as illustrated in FIG. 1, that the upper insertion part 121 of the upper terminal plate 120 may pass through the upper through hole 151_1 to protrude upwardly more than the upper part 151 of the outer case 150. In another example, the upper terminal plate 120 may not include the upper insertion part 121 passing through the upper through hole 151_1. In yet another example, the upper terminal plate 120 may include the upper insertion part 121 passing through the upper through hole 151_1, but the upper insertion part 121 may not protrude more than the upper part 151 of the outer case 150.

In some embodiments, a lower through hole 153_1 may be formed in a central portion of the lower part 153 of the outer case 150. The lower terminal plate 130 may seal the lower through hole 153_1 formed in the central portion of the lower part 153. For example, at least a portion of the lower terminal plate 130 may pass through the lower through hole 153_1 formed in the central portion of the lower part 153.

In some embodiments, the lower terminal plate 130 may include a lower insertion part 131 and a lower flange part 132. For example, in relation to the outer case 150, the lower insertion part 131 may pass through the lower through hole 153_1 formed in the central portion of the lower part 153 of the outer case 150. The lower flange part 132 may extend outwardly from the lower insertion part 131 and, in relation to the outer case 150, the lower flange part 132 may be joined to a top surface of the lower part 153 of the outer case 150. In relation to the inner case 140, the lower flange part 132 may cover the lower opening of the inner case 140 and the lower flange part 132 may be electrically coupled to the second electrode of the electrode assembly 110. For example, referring to FIG. 1, a peripheral region of the lower terminal plate 130 (e.g. an edge of the lower flange part 132) may be inserted between and held between a lowermost surface of the inner case 140 (e.g., a surface of the inner sidewall part 140a facing the lower part 153) and the top surface of the lower part 153 (e.g., a surface of the lower part 153 facing the inner case 140) along an entire circumference of the inner case 140.

For example, as illustrated in FIG. 1, the lower insertion part 131 of the lower terminal plate 130 may pass through the lower through hole 153_1 to protrude downwardly more than the lower part 153 of the outer case 150. In another example, the lower terminal plate 130 may not include the lower insertion part 131 passing through the lower through hole 153_1. In yet another example, the lower terminal plate 130 may include the lower insertion part 131 passing through the lower through hole 153_1, but the lower insertion part 131 may not protrude more than the lower part 153 of the outer case 150.

In some embodiments, the structure between the upper part 151 of the outer case 150 and the upper terminal plate 120 may be independent of the structure between the lower part 153 of the outer case 150 and the lower terminal plate 130. For example, as illustrated in FIG. 1, the upper part 151 and the lower part 153 of the outer case 150, and the upper terminal plate 120 and the lower terminal plate 130 may be symmetrical to each other, respectively.

For example, a length that the upper part 151 of the outer case 150 extends inwardly from the outer sidewall part 152 may be different from a length that the lower part 153 of the outer case 150 extends inwardly from the outer sidewall part 152. In another example, a position that the upper insertion part 121 of the upper terminal plate 120 protrudes in the upper terminal plate 120 and a depth that the upper insertion part 121 passes through the upper through hole 151_1 may be the same as or different from a position that the lower insertion part 131 of the lower terminal plate 130 protrudes in the lower terminal plate 130 and a depth that the lower insertion part 131 passes through the lower through hole 153_1.

FIG. 2 is a perspective view exemplarily illustrating the outer case 150, which includes the outer sidewall part 152 surrounding the inner case 140 and the lower part 153 joined to the lower terminal plate 130, before the upper part 151 joined to the upper terminal plate 120 is formed.

Referring to FIG. 2, the first electrode, the separator, and the second electrode of the electrode assembly 110 may be sequentially stacked and wound. In some embodiments, the tubular inner case 140 may have a tube shape with a ring-shaped cross section or a circular-shaped cross-section. The outer case 150 may accommodate the inner case 140 in the inside thereof. For example, the outer sidewall part 152 of the outer case 150 surrounding the inner case 140 may have a hollow circular or tubular shape corresponding to the inner case 140. In this example, an inner diameter R4 of the tubular-shaped part of the outer case 150 may be equal to or larger than the outer diameter R2 of the inner sidewall part 140a of the inner case 140.

The outer case 150 may be configured of a chemically resistant, thermoplastic, and insulating material. For example, the outer case 150 may include at least one of polypropylene (PP), polyethylene (PE), fluoroelastomer (FKM), polybutylene terephthalate (PBT), ethylene propylene diene monomer (EPDM), polyvinylidene fluoride (PVDF), polytetrafluoroethylene (PTFE), and silicon rubber.

Each of the inner case 140 and the outer case 150 may be configured of (e.g., formed of or consist essentially of) an insulating material, and each of the upper terminal plate 120 and the lower terminal plate 130 may be configured of a conductive material. Accordingly, the short circuit among the upper terminal plate 120, the lower terminal plate 130, the inner case 140, and the outer case 150 may not occur even when an insulating tape, a gasket, an insulator, and the like are not separately included.

In some embodiments, the outer case 150 may be configured of an insulating material having high formability. For example, the upper part 151 or the lower part 153 of the outer case 150 may be formed by physically pressurizing portions of a tube longitudinally extending from the tubular outer sidewall part 152 in parallel. In another example, the upper part 151 or the lower part 153 of the outer case 150 may be formed by heating the portions of the tube.

In some embodiments, the formability of the outer case 150 may be equal to or greater than that of the inner case 140. A thickness of the outer case 150 may be equal to or smaller than a thickness of the inner case 140. For example, the thickness of the outer case 150 may refer to a distance between an inner surface and an outer surface of the tubular outer sidewall part 152

$$( i . e . , ( \frac{R 5 - R 4}{2} ) ) .$$

For example, the thickness of the inner case 140 may refer to a distance between an inner surface and an outer surface of the inner sidewall part 140a

$$( i . e . , ( \frac{R 2 - R 3}{2} ) ) .$$

Through the above-described configuration, the insulating outer case 150 may be joined to the conductive terminal plates 120 and 130 to be sealed through physical pressurization or heat staking without a separate welding process, and thus the secondary battery manufacturing process may be simplified in terms of cost and time. The cell internal performance degradation or the safety issues due to high temperature heat or spark generated in welding may be reduced. Further, the short circuit in the separator between two electrodes, precipitation of Li metal, or decompression of the electrolyte in the Li-ion battery, which is caused by heat generated in welding, may be prevented, and thus explosion probability may be minimized.

Through the above-described configuration, the insulating inner case 140 having a tubular shape may serve as an inner frame of the secondary battery 100. The inner case 140 may include the tubular inner sidewall part surrounding the electrode assembly 110 and the openings sealed by the terminal plates. When the upper part 151 and the lower part 153 of the outer case 150 are formed by physically pressurizing the outer case 150, the inner case 140 may serve as a structural framework of the secondary battery to prevent the electrode assembly 110 from being damaged and to ensure the stability of the secondary battery.

Through the above-described configuration, the automatic alignment of the electrode assembly 110, the inner case 140, the terminal plates 120 and 130, and the outer case 150 may be performed according to the relation of relative sizes (diameter, inner diameter, outer diameter) thereof, and thus the structural stability of the secondary battery may be improved.

FIG. 3 is a cross-sectional view illustrating a secondary battery according to some embodiments of the present disclosure. In FIG. 3, an upper terminal plate 320 may include an upper insertion part 321 and an upper flange part 322. Detailed descriptions of portions of the secondary battery in FIG. 3 which overlap the secondary battery in FIGS. 1 and 2 will be omitted.

Referring to FIG. 3, in some embodiments, the upper insertion part 321 may pass through an upper through hole formed in a central portion of an upper part 351 of an outer case 350. The upper flange part 322 may be joined to the upper part 351 formed by a pressure jig and the like. In some embodiments, the upper flange part 322 may be electrically coupled to a first electrode of an electrode assembly 310 accommodated in the inside of an inner case 340. The upper flange part 322 may be joined to an upper opening of the inner case 340. Accordingly, the upper opening of the inner case 340 may be sealed by the upper terminal plate 320.

Referring to FIG. 3, in some embodiments, in a cylindrical type secondary battery, a coin type secondary battery, and a button type secondary battery, a diameter of the upper terminal plate 320 may be larger than an inner diameter of the inner case 340 and smaller than an outer diameter of the inner case 340.

In some embodiments, a first upper portion 351_1 of the upper part 351 of the outer case 350 may be joined to the upper flange part 322 of the upper terminal plate 320 (e.g., the first upper portion 351_1 may contact and overlap a topmost surface of the upper flange part 322). A second upper portion 351_2 of the upper part 351 of the outer case 350 may be joined to a side surface of the upper flange part 322 and a portion of the inner case 340 to fill a space formed in a case where the diameter of the upper terminal plate 320 is larger than the inner diameter of the inner case 340 and smaller than the outer diameter of the inner case 340 (e.g., the second upper portion 351_2 may contact a lateral side surface of the upper flange part 322 and may contact and overlap a topmost surface of the inner case 340). For example, both the first and second upper portions 351_1 and 351_2 may extend from a tubular outer sidewall part 352.

In some embodiments, a lower insertion part 331 may pass through a lower through hole formed in a central portion of a lower part 353 of the outer case 350. A lower flange part 332 may be joined to the lower part 353 formed by a pressure jig and the like.

In some embodiments, the lower flange part 332 may be electrically coupled to a second electrode of the electrode assembly 310 accommodated in the inside of the inner case 340. The lower flange part 332 may be joined to the lower opening of the inner case 340. Accordingly, the lower opening of the inner case 340 may be sealed by the lower terminal plate 330.

Referring to FIG. 3, in some embodiments, in a cylindrical type secondary battery, a coin type secondary battery, and a button type secondary battery, a diameter of the lower terminal plate 330 may be larger than the inner diameter of the inner case 340 and smaller than the outer diameter of the inner case 340.

In some embodiments, the lower part 353 of the outer case 350 may be joined to the lower flange part 322 of the lower terminal plate 330. A space formed in a case where the diameter of the lower terminal plate 330 is larger than the inner diameter of the inner case 340 and smaller than the outer diameter of the inner case 340 may not be filled with the lower part 353, separately.

For example, as illustrated in FIG. 3, the upper structure and the lower structure of the secondary battery may have different specific structures, as described above. In another example, the upper structure and the lower structure may have the same structures, e.g., both may have an unfilled space adjacent to the flange part or both have a portion of the outer case 350 fill the space adjacent to the flange part.

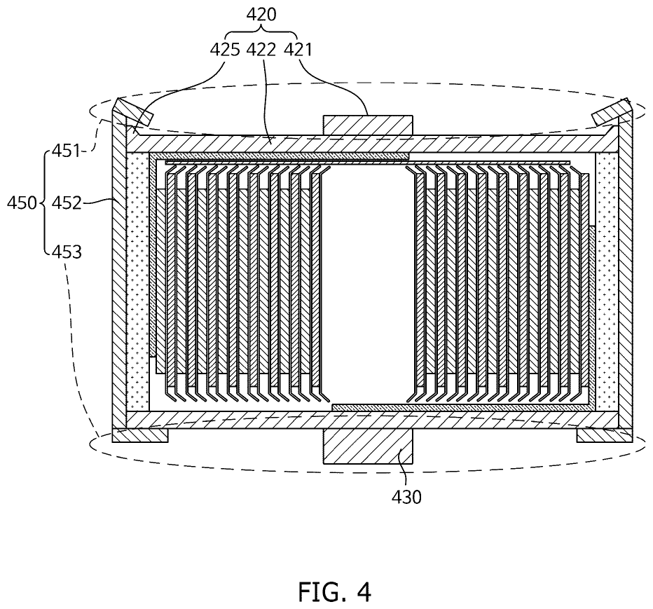

FIG. 4 is a cross-sectional view illustrating a secondary battery according to some embodiments of the present disclosure. In FIG. 4, an upper terminal plate 420 may include an upper insertion part 421, an upper flange part 422, and a crimpling fixing part 425. Detailed descriptions of portions of the secondary battery in FIG. 4 which overlap the secondary batteries in FIGS. 1 to 3 will be omitted.

Referring to FIG. 4, in some embodiments, an upper part 451 of an outer case 450 may be formed to have a height which is reduced inwardly, and the upper terminal plate 420 may include the crimpling fixing part 425 in a surface which is in contact with an outer sidewall part 452 the outer case 450. For example, the upper part 451 may be configured that an inner portion is bent downwardly, e.g., the upper part 451 may be bent at an oblique angle toward the crimpling fixing part 425.

In some embodiments, the upper part 451 may be formed to be in contact with the crimpling fixing part 425. For example, the crimpling fixing part 425 may be formed to be more gently inclined, and the upper part 451 may be disposed to correspond to (e.g., vertically overlap) at least a portion of an inclined surface of the crimpling fixing part 425.

For example, a lower part 453 of the outer case 450 may be formed to have a height which is increased inwardly, and a lower terminal plate 430 may include a crimpling fixing part in a surface which is in contact with the outer case 450. The lower part 453 may be configured that an inner portion is bent upwardly. In another example, as illustrated in FIG. 4, the lower part 453 of the outer case 450 may be flat and parallel to the upper flange part 422.

Through the above-described configuration, the adhesiveness between the outer case 450 and the terminal plates 420 and 430 may be improved.

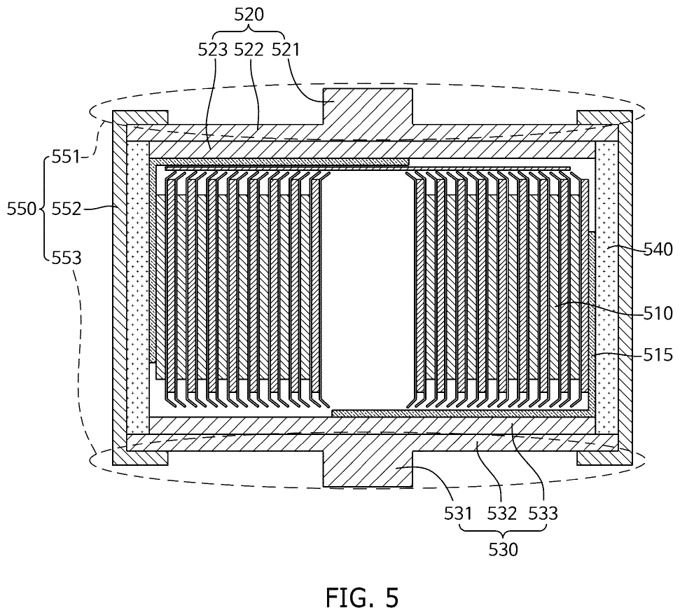

FIG. 5 is a cross-sectional view illustrating a secondary battery according to some embodiments of the present disclosure. In FIG. 5, an upper terminal plate 520 may include an upper insertion part 521, an upper flange part 522, and an upper current collecting plate 523, and a lower terminal plate 530 may include a lower insertion part 531, a lower flange part 532, and a lower current collecting plate 533. For example, it will be described below that the upper current collecting plate 523 and the lower current collecting plate 533 are included in the upper terminal plate 520 and the lower terminal plate 530, respectively. In another example, the upper current collecting plate 523 and the lower current collecting plate 533 may not be included in the upper terminal plate 520 and the lower terminal plate 530, respectively, and may be provided separately from the upper terminal plate 520 and the lower terminal plate 530. Detailed descriptions of portions of the secondary battery in FIG. 5 which overlap the secondary batteries in FIGS. 1 to 4 will be omitted.

Referring to FIG. 5, in some embodiments, the upper insertion part 521 may pass through an upper through hole formed in a central portion of the upper part 551 of an outer case 550. The upper flange part 522 may extend outwardly from the upper insertion part 521 and may be joined to a folded portion of the upper part 551 formed by a pressure jig and the like. The upper current collecting plate 523 may extend downwardly from a portion of the upper flange part 522 and may be electrically coupled to a first electrode (or a first electrode tab) of an electrode assembly 510 accommodated in an inner case 540.

Referring to FIG. 5, in some embodiments, the upper current collecting plate 523 included in the upper terminal plate 520 may be surrounded with a tubular inner sidewall part of the inner case 540. For example, a diameter of the upper current collecting plate 523 may be smaller than an inner diameter of the inner case 540.

Referring to FIG. 5, in some embodiments, the upper flange part 522 included in the upper terminal plate 520 may be joined to an upper opening of the inner case 540 to cover the upper opening of the inner case 540. For example, in FIG. 5, a diameter of the upper terminal plate 520 may be larger than the inner diameter of the inner case 540 and equal to an outer diameter of the inner case 540, and the diameter of the upper terminal plate 520 may be equal to or smaller than an inner diameter of a tubular outer sidewall part 552 of the outer case 550.

Referring to FIG. 5, in some embodiments, the lower terminal plate 530 may be configured to correspond to the upper terminal plate 520.

In some embodiments, the lower insertion part 531 may pass through a lower through hole formed in a central portion of a lower part 553 of the outer case 550. The lower flange part 532 may extend outwardly from the lower insertion part 531 and may be joined to a folded portion of the lower part 553 formed by a pressure jig and the like. The lower current collecting plate 533 may extend upwardly from a portion of the lower flange part 532 and may be electrically coupled to a second electrode (or a second electrode tab 515) of the electrode assembly 510 accommodated in the inner case 540.

Referring to FIG. 5, in some embodiments, the lower current collecting plate 533 included in the lower terminal plate 530 may be surrounded with the tubular inner sidewall part of the inner case 540. For example, a diameter of the lower current collecting plate 533 may be smaller than the inner diameter of the inner case 540.

Referring to FIG. 5, in some embodiments, the lower flange part 532 included in the lower terminal plate 530 may be joined to a lower opening of the inner case 540 to cover the lower opening of the inner case 540. For example, in FIG. 5, a diameter of the lower terminal plate 530 may be larger than the inner diameter of the inner case 540 and equal to the outer diameter of the inner case 540, and the diameter of the lower terminal plate 530 may be equal to or smaller than an inner diameter of the tubular outer sidewall part 552 of the outer case 550.

Through the above-described configuration, the automatic alignment performance of the upper terminal plate 520, the lower terminal plate 530, the inner case 540, and the outer case 550 may be improved, and the adhesiveness thereof may be improved.

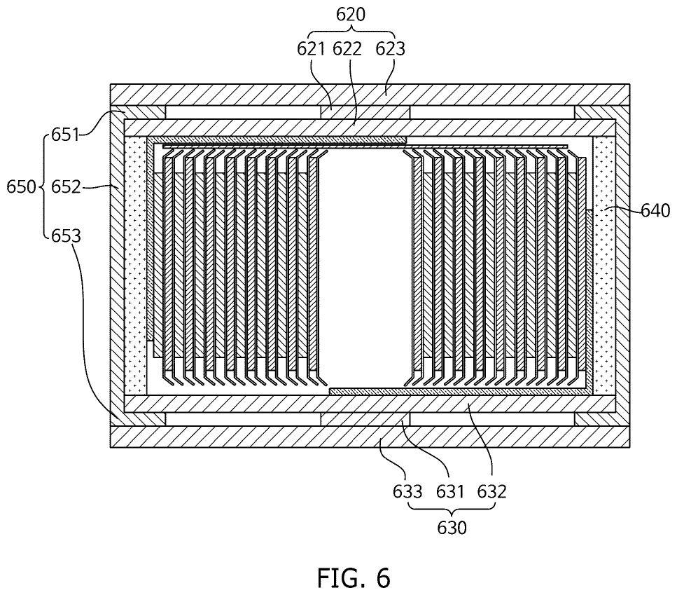

FIG. 6 is a cross-sectional view illustrating a secondary battery according to some embodiments of the present disclosure. In FIG. 6, an upper terminal plate 620 may include an upper insertion part 621, an upper flange part 622, and an upper rivet terminal 623. Detailed descriptions of portions of the secondary battery in FIG. 6 which overlap the secondary batteries in FIGS. 1 to 5 will be omitted.

Referring to FIG. 6, in some embodiments, at least a portion of the upper terminal plate 620 may pass through an upper through hole formed in a central portion of an outer case 650. For example, the upper insertion part 621 of the upper terminal plate 620 may pass through the upper through hole formed in a central portion of the upper part 651 of the outer case 650 (extending from a tubular outer sidewall part 652). The upper flange part 622 may extend outwardly from the upper insertion part 621 and in relation to the outer case 650, the upper flange part 622 may be joined to the upper part 651 formed by a pressure jig and the like.

In some embodiments, the upper rivet terminal 623 may be disposed over the upper insertion part 621 and joined to a top surface of the upper part 651 of the outer case 650. Referring to FIG. 6, a bottom surface of the upper part 651 may be joined to the upper flange part 622 included in the upper terminal plate 620, and the top surface of the upper part 651 may be joined to the upper rivet terminal 623 included in the upper terminal plate 620.

In some embodiments, a lower terminal plate 630 may include a lower insertion part 631, a lower flange part 632, and a lower rivet terminal 633.

In some embodiments, at least a portion of the lower terminal plate 630 may pass through a lower through hole formed in a central portion of the outer case 650. For example, the lower insertion part 631 of the lower terminal plate 630 may pass through the lower through hole formed in a central portion of the lower part 653 of the outer case 650. The lower flange part 632 may extend outwardly from the lower insertion part 631 and in relation to the outer case 650, the lower flange part 632 may be joined to the lower part 653 formed by a pressure jig and the like.

In some embodiments, the lower rivet terminal 633 may be disposed below the lower insertion part 631 and joined to a bottom surface of the lower part 653 of the outer case 650. Referring to FIG. 6, a top surface of the lower part 653 may be joined to the lower flange part 632 included in the lower terminal plate 630, and a bottom surface of the lower part 653 may be joined to the lower rivet terminal 633 included in the lower terminal plate 630.

Through the above-described configuration, the adhesiveness between the outer case 650, the inner case 640, and the terminal plates 620 and 630 may be improved.

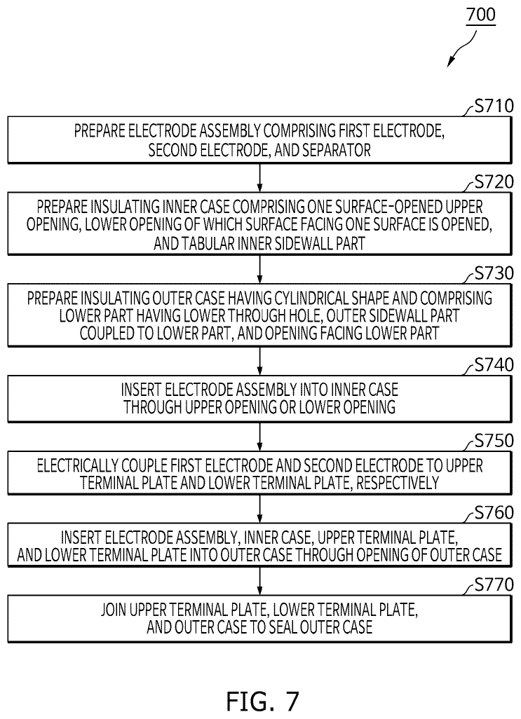

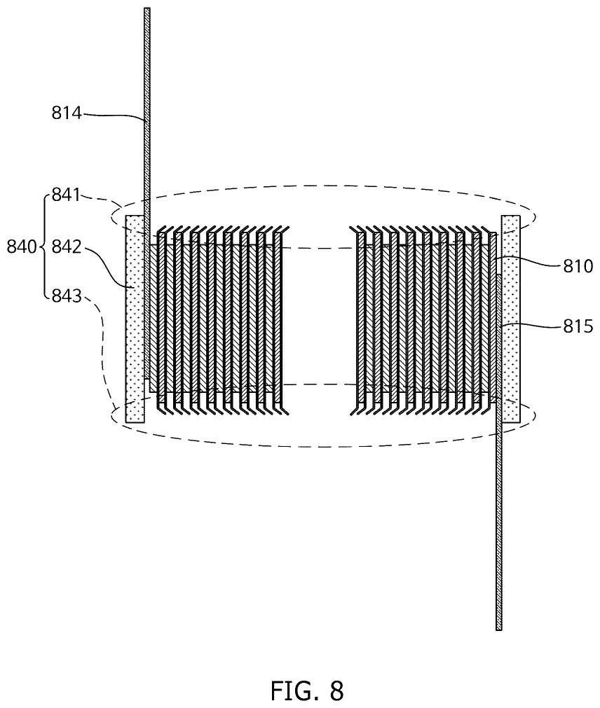

FIG. 7 is a flowchart explaining a method for manufacturing a secondary battery according to some embodiments of the present disclosure. FIGS. 8 to 14 are process diagrams explaining stages in a method for manufacturing a secondary battery according to some embodiments of the present disclosure.

Referring to FIGS. 7 and 8, the secondary battery manufacturing method may start with preparing an electrode assembly 810 including a first electrode, a second electrode, and a separator (S710). For example, preparing the electrode assembly 810 may include electrically coupling a first electrode tab 814 and the first electrode, and additionally or alternatively, coupling a second electrode tab 815 and the second electrode.

Referring to FIGS. 7 and 8, an inner case 840, which is configured of an insulating material and includes an upper opening 841 of which one surface is opened, a lower opening 843 of which a surface facing the one surface is opened, and an inner sidewall part 842 having a tubular shape, may be prepared (S720). In some embodiments, preparing (S720) of the inner case 840 may be performed in sequence to or in parallel with preparing (S710) of the electrode assembly 810.

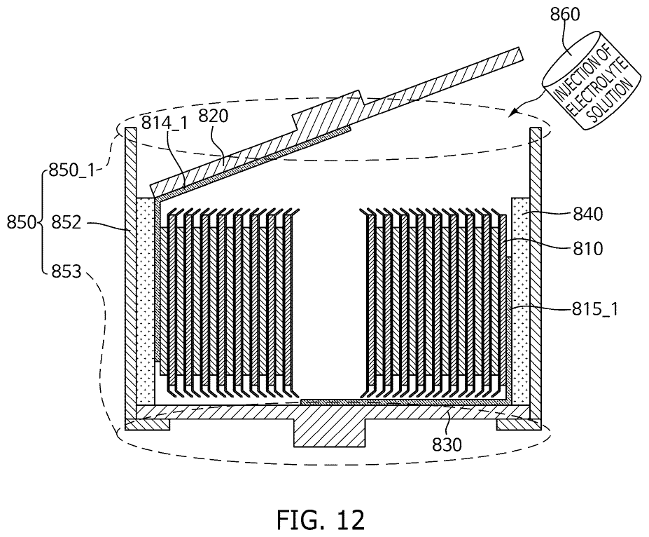

Referring to FIGS. 7 and 12, an outer case 850 having a cylindrical shape, which is configured of an insulating material and includes a lower part 853 including a lower through hole, an outer sidewall part 852 coupled to the lower part 853, and an opening facing the lower part 853, may be prepared (S730). In some embodiments, preparing (S730) the outer case 850 may be performed in sequence to or in parallel with the preparing (S720) of the inner case 840. In other embodiments, the process order of preparing (S710) of the electrode assembly 810, preparing (S720) of the inner case 840, and preparing (S730) of the outer case 850 may be changed.

Next, referring to FIGS. 7 and 8, the electrode assembly 810 may be inserted into the inner case 840 through the upper opening 841 or the lower opening 843 of the inner case 840 (S740). Accordingly, the electrode assembly 810 may be surrounded with the inner sidewall part 842 of the inner case 840.

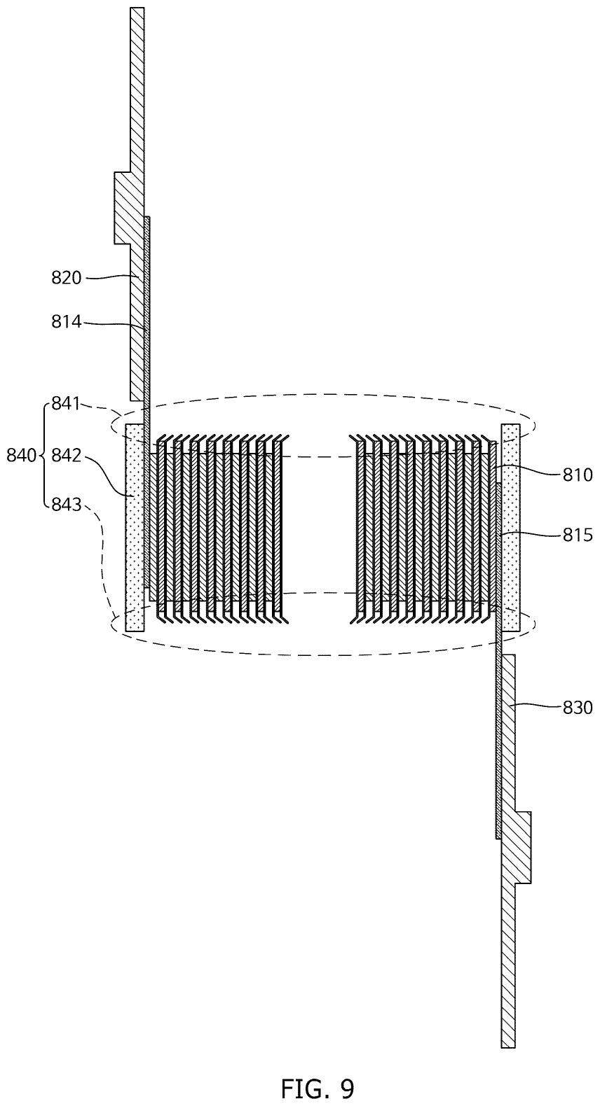

Referring to FIGS. 7 and 9, the first electrode and the second electrode of the electrode assembly 810 may be electrically coupled to the upper terminal plate 820 and the lower terminal plate 830, respectively (S750). For example, electrically coupling the first electrode of the electrode assembly 810 and the upper terminal plate 820 may include welding at least a portion of the first electrode tab 814 and at least a portion of the upper terminal plate 820 to electrically couple the first electrode of the electrode assembly 810 and the upper terminal plate 820. Electrically coupling of the second electrode of the electrode assembly 810 and the lower terminal plate 830 may include welding a least a portion of the second electrode tab 815 and at least a portion of the lower terminal plate 830 to couple the second electrode of the electrode assembly 810 and the lower terminal plate 830.

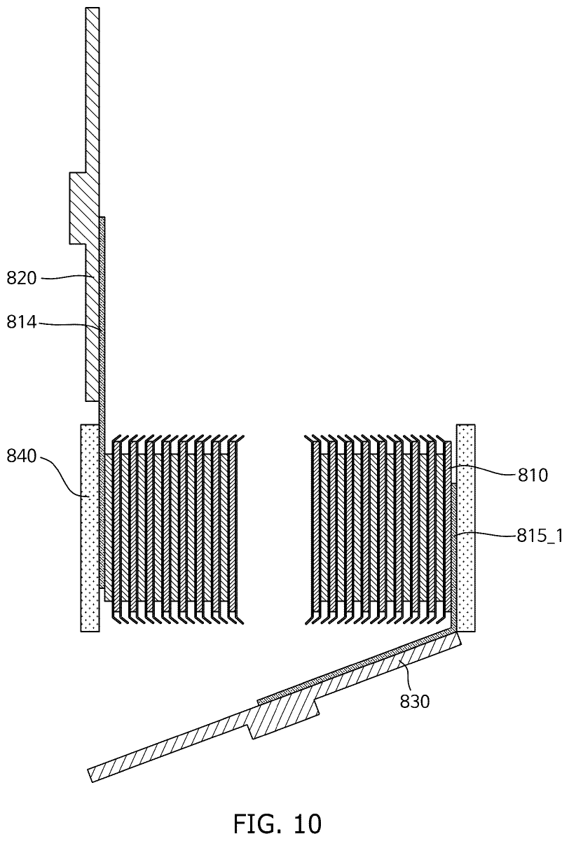

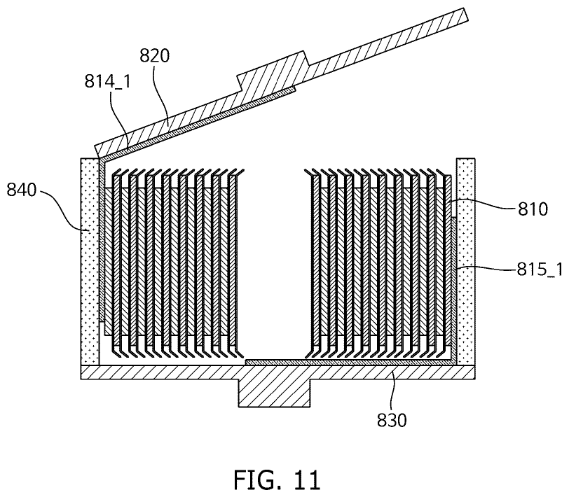

Referring to FIGS. 7 and 10, the second electrode tab 815_1 may be bent or folded so that the lower terminal plate 830 may cover the lower opening 843 of the inner case 840. Referring to FIGS. 7 and 11, the first electrode tab 814_1 may be bent or folded so that the upper terminal plate 820 may cover the upper opening 841 of the inner case 840. In some embodiments, the bending or folding of the first electrode tab 814-1 may be performed sequentially or alternatively to the bending or folding of the second electrode tab 815_1.

Referring to FIGS. 7 and 12, the electrode assembly 810, the inner case 840, the upper terminal plate 820, and the lower terminal plate 830 may be inserted into the outer case 850 through an opening 850_1 of the outer case 850 (S760). In some embodiments, inserting (S760) the electrode assembly 810, the inner case 840, the upper terminal plate 820, and the lower terminal plate 830 into the outer case 850 through the opening 850_1 may include passing at least a portion of the lower terminal plate 830 through the lower through hole, and additionally or alternatively injecting an electrolyte solution 860 into the inside of the outer case 850. Next, a process of impregnating the electrolyte solution to the electrode assembly may be performed for a predetermined time.

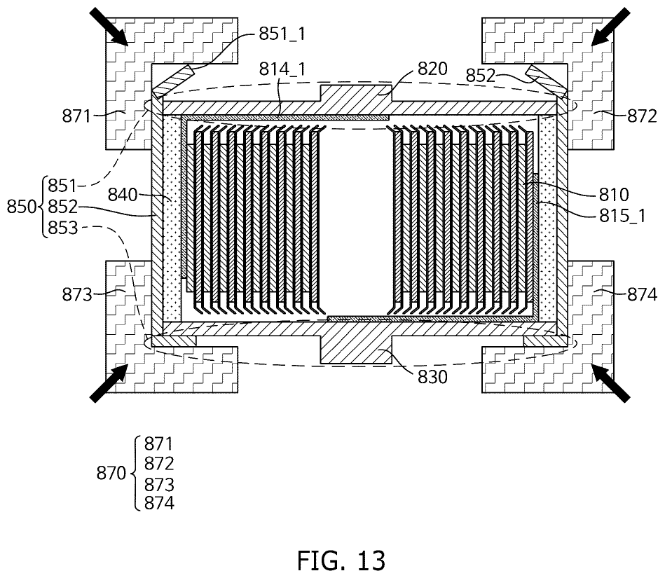

Referring to FIGS. 7 and 13, the upper terminal plate 820, the lower terminal plate 830, and the outer case 850 may be joined to seal the outer case 850 (S770). In some embodiments, sealing (S770) of the outer case 850 may include sealing the outer case 850 by pressurizing the outer case 850 through a pressure jig. For example, the pressure jig 870 may include a first pressure jig 871 and a second pressure jig 872 configured to pressurize portions of an upper part 851 of the outer case 850, a third pressure jig 873 and a fourth pressure jig 874 configured to pressurize portions of the lower part 853 of the outer case 850, and the like. At least a portion of the upper part 851 of the outer case 850 may be a folded portion 851_1 which is crimped and folded toward an upper flange part side of the upper terminal plate 820. By the physical deformation of the outer case 850 through the above-described configuration, the upper terminal plate 820, the lower terminal plate 830, the inner case 840, and the outer case 850 may be shielded and sealed from the outside.

In some embodiments, the pressure jig 870, which is configured to pressurize the outer case 850 including insulating polymer and the like, may include a material, such as aluminum, hardened aluminum, bronze, brass, nylon, acetal, reinforced plastic, polyurethane, Teflon coating, nylon insert, tungsten carbide, high-carbon steel, or stainless steel. For example, a frame of pressure equipment including the pressure jig may be configured of aluminum to provide sufficient strength and corrosion resistance. A compression die may be manufactured of hardened aluminum or bronze and designed to minimize damage of a surface of the outer case 850 and to ensure uniform and accurate pressurization. A surface of the pressure jig 870 which is in contact with the outer case 850 may be configured of nylon, polyurethane, or the like to softly pressurize the outer case 850. The frame of the pressure jig 870 may include stainless steel or aluminum to provide high strength and corrosion resistance, and the compression die of the pressure jig 870 may include ceramic-coated steel to provide heat resistance and wear resistance and to minimize friction with the outer case 850. The contact surface of the pressure jig 870 may be coating-treated with rubber or silicon to prevent damage of the outer case 850.

Through the above-described configuration, the pressure jig 870 may endure heat which may occur in pressurizing the outer case 850. The pressure jig 870 may apply uniform pressure to the surface of the outer case 850, and thus regardless of repeated pressurization, the abrasion may be prevented and the uniform quality may be maintained.

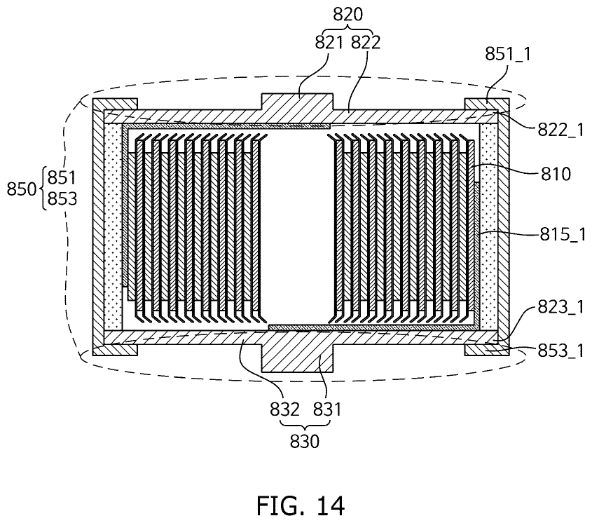

Referring to FIG. 14, the upper part 851 of the outer case 850 may be crimped and pressurized to be joined to at least a portion 822_1 of an upper flange part 822 of the upper terminal plate 820. The lower part 853 of the outer case 850 may be crimped and pressurized to be joined to at least a portion 832_1 of a lower flange part 832 of the lower terminal plate 830. Accordingly, the secondary battery in which the outer case 850 is shield from the outside can be manufactured.

In some embodiments, the folded portion 851_1 in the upper part 851 of the outer case 850, which is physically folded by the pressure jig, may be bound with the at least a portion 822_1 of the upper flange part 822. Similarly, a folded portion 853_1 in the lower part 853 of the outer case 850, which is physically folded by the pressure jig, may be bound with the at least a portion 832_1 of the lower flange part 832.

Additionally or alternatively, the upper terminal plate 820, the lower terminal plate 830, the inner case 840, and the outer case 850 may be aligned. For example, the upper terminal plate 820, the lower terminal plate 830, the inner case 840, and the outer case 850 may be automatically aligned by the relative sizes of the respective configurations.

The flowchart of FIG. 7 and the process diagrams of FIGS. 8 to 14, and the detailed description thereof are merely examples of the present disclosure, and the scope of the present disclosure is not limited to the flowchart of FIG. 7 and the detailed description therefor. For example, one or more processes in the flowchart, the process diagrams, and the detailed description thereof may be added/changed/deleted, the order of one or more processes may be changed, and one or more processes may be performed simultaneously.

By way of summation and review, in the manufacturing process of a secondary battery, a method for shielding external air by welding a case and a cap plate has been used. However, heat generated in the welding process may affect a chemical material inside of a cell to cause performance degradation or safety issues. For example, in a lithium-ion battery, short circuit in a separator between two electrodes may occur, lithium metal may be precipitated, or an electrolyte may be decomposed, and thus a risk of explosion may be increased. Since the welding process itself is complex, manufacturing costs and time may be increased, defective products may occur in the welding process, or rework may be required, thereby degrading production efficiency.

In contrast, aspects of embodiments of the present disclosure provide a secondary battery and a method for manufacturing the same, where an insulating outer case may be joined to a conductive terminal plate to be sealed through physical pressurization or heat staking without a separate welding process. Accordingly, the manufacturing process of a secondary battery may be simplified in terms of costs and time.

According to some embodiments of the present disclosure, internal performance degradation of a cell or safety issues due to high temperature heat or spark generated in welding may be reduced.

According to some embodiments of the present disclosure, possibility of explosion in a Li-ion battery due to short circuit in a separator between two electrodes, precipitation of Li metal, or decomposition of an electrolyte, which is caused by to heat generated in welding, may be minimized.

According to some embodiments of the present disclosure, welding defects such as damage of an electrode assembly, deformation of a finishing tape, and the like due to welding heat, which may occur in a welding process of a case and a terminal plate, may be fundamentally prevented.

According to some embodiments of the present disclosure, as an inner case and an outer case are configured of an insulating material, an insulating member for insulating the cases and an electrode terminal, a terminal plate, and a cap assembly may be omitted, and the cases may be disposed to be in direct contact with the terminal plate. Accordingly, a space, which may not contribute to battery capacity, in an inside of a battery may be minimized to increase energy density of the battery and to cost down in a battery manufacturing process.

According to some embodiments of the present disclosure, battery short circuit between a terminal plate and a case may be fundamentally prevented.

According to some embodiments of the present disclosure, an insulating tubular inner case may serve as an inner frame of a secondary battery. The inner case may include an inner sidewall part having a tubular shape and surrounding an electrode assembly and an opening sealed by a terminal plate. In a process for forming an upper part and a lower part by physically pressurizing an outer case, the inner case may serve as a protective film of the electrode assembly, and thus stability of a secondary battery may be maintained.

According to some embodiments of the present disclosure, automatic alignment may be performed according to relation of relative sizes of an electrode assembly, an inner case, a terminal plate, and an outer case, and thus structural stability of a secondary battery may be improved.

However, aspects and features of the present disclosure are not limited to those described above, and other aspects and features not mentioned will be clearly understood by a person skilled in the art from the detailed description, described above.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
an electrode assembly including a first electrode, a second electrode, and a separator;
an inner case including an upper opening of which a first surface is open, a lower opening of which a second surface facing the first surface is open, and a tubular inner sidewall surrounding the electrode assembly;
an upper terminal plate joined to the upper opening and electrically coupled to the first electrode;
a lower terminal plate joined to the lower opening and electrically coupled to the second electrode; and
an outer case including a tubular outer sidewall surrounding the inner case, an upper part extending inwardly from the tubular outer sidewall and joined to the upper terminal plate, and a lower part extending inwardly from the tubular outer sidewall and joined to the lower terminal plate,
wherein the inner case and the outer case include an insulating material.

2. The secondary battery as claimed in claim 1, wherein:
the upper terminal plate is configured to seal an upper through hole in a central portion of the upper part of the outer case, and
the lower terminal plate is configured to seal a lower through hole in a central portion of the lower part of the outer case.

3. The secondary battery as claimed in claim 1, wherein:
at least a portion of the upper terminal plate passes through an upper through hole in a central portion of the upper part of the outer case, and
at least a portion of the lower terminal plate passes through a lower through hole in a central portion of the lower part of the outer case.

4. The secondary battery as claimed in claim 1, wherein:
the upper terminal plate includes an upper insertion part which passes through an upper through hole in a central portion of the upper part of the outer case, and an upper flange part which extends outwardly from the upper insertion part and is joined to a bottom surface of the upper part of the outer case, and
the lower terminal plate includes a lower insertion part which passes through a lower through hole in a central portion of the lower part of the outer case, and a lower flange part which extends outwardly from the lower insertion part and is joined to a top surface of the lower part of the outer case.

5. The secondary battery as claimed in claim 4, wherein:
the upper terminal plate further includes an upper rivet terminal over the upper insertion part and joined to a top surface of the upper part of the outer case, and
the lower terminal plate further includes a lower rivet terminal below the lower insertion part and joined to a bottom surface of the lower part of the outer case.

6. The secondary battery as claimed in claim 1, wherein:
the upper terminal plate and the lower terminal plate include a conductive material, and
the electrode assembly includes a first electrode and a first electrode tab electrically coupled to the upper terminal plate, and a second electrode and a second electrode tab electrically coupled to the lower terminal plate.

7. The secondary battery as claimed in claim 6, wherein:
the first electrode is welded to the upper terminal plate to be coupled to the upper terminal plate; and
the second electrode is welded to the lower terminal plate to be coupled to the lower terminal plate.

8. The secondary battery as claimed in claim 1, wherein the inner case and the outer case include a thermoplastic material that is chemically resistant.

9. The secondary battery as claimed in claim 8, wherein the thermoplastic material includes at least one of fluoroelastomer (FKM), polybutylene terephthalate (PBT), ethylene propylene diene monomer (EPDM), polyvinylidene fluoride (PVDF), polytetrafluoroethylene (PTFE), and silicon rubber.

10. The secondary battery as claimed in claim 1, wherein a thickness of the outer case is equal to or smaller than a thickness of the inner case.

11. The secondary battery as claimed in claim 1, wherein:
the upper part of the outer case has a height reduced inwardly, and
the upper terminal plate includes a crimping fixing part in a surface which is in contact with the outer case.

12. The secondary battery as claimed in claim 1, wherein the secondary battery includes a coin cell or a button cell.

13. The secondary battery as claimed in claim 1, wherein a height of the inner case is equal to or smaller than a height of the electrode assembly.

14. The secondary battery as claimed in claim 1, wherein:
the electrode assembly includes the first electrode, the second electrode, and the separator in a wound structure,
the upper terminal plate has a circular plate shape, and
a diameter of the upper terminal plate is larger than an inner diameter of the inner case and equal to or smaller than an outer diameter of the inner case.

15. A method of manufacturing a secondary battery, the method comprising;
preparing an electrode assembly including a first electrode, a second electrode, and a separator;
preparing an inner case of an insulating material, such that the inner case includes an upper opening of which one surface is opened, a lower opening of which a surface facing the one surface is opened, and a tubular inner sidewall;
preparing an outer case having a cylindrical shape and formed of an insulating material, such that the outer case includes a lower part having a lower through hole, an outer sidewall coupled to the lower part, and an opening facing the lower part;
inserting the electrode assembly into the inner case through the upper opening or the lower opening;
electrically coupling the first electrode and the second electrode to an upper terminal plate and a lower terminal plate, respectively;
inserting the electrode assembly, the inner case, the upper terminal plate, and the lower terminal plate into the outer case through the opening of the outer case; and
joining the upper terminal plate, the lower terminal plate, and the outer case to each other to seal the outer case.

16. The method as claimed in claim 15, wherein:
preparing the electrode assembly includes:
electrically coupling a first electrode tab to the first electrode; and
electrically coupling a second electrode tab to the second electrode, and
electrically coupling the first electrode and the second electrode to the upper terminal plate and the lower terminal plate includes:
welding at least a portion of the second electrode tab and at least a portion of the lower terminal plate; and
bending the second electrode tab so that the lower terminal plate covers the lower opening.

17. The method as claimed in claim 16, wherein electrically coupling the first electrode and the second electrode to the upper terminal plate and the lower terminal plate further includes:
welding at least a portion of the first electrode tab and at least a portion of the upper terminal plate to electrically couple the first electrode and the upper terminal plate; and
bending the first electrode tab so that the upper terminal plate covers the upper opening.

18. The method as claimed in claim 15, wherein inserting the outer case includes:
passing at least a portion of the lower terminal plate through the lower through hole; and
injecting an electrolyte solution into an inside of the outer case.

19. The method as claimed in claim 15, further comprising aligning the upper terminal plate, the lower terminal plate, the inner case, and the outer case.

20. The method as claimed in claim 15, where sealing the outer case includes pressurizing the outer case through a pressure jig.
